(19) United States
(12) Patent Application Publication
(10) Pub. No.: US 2025/0235991 A1
(43) Pub. Date: Jul. 24, 2025

(54) SINGLE-HAND QUICK-PRESS RELEASE SOCKET ADAPTER

(71) Applicant: RE-DAI PRECISION TOOLS CO.,LTD., Taichung City (TW)

(72) Inventors: HSIANG CHEN YU, Taichung City (TW); I CHIU CHOU, Taichung City (TW)

(21) Appl. No.: 19/018,533

(22) Filed: Jan. 13, 2025

(30) Foreign Application Priority Data
Jan. 18, 2024 (TW) 113102057

(51) Int. Cl. B25B 23/00; B25B 13/06

(52) U.S. Cl. CPC B25B 23/0035; B25B 13/06

(57) ABSTRACT

A single-hand quick-press release socket adapter includes a rod and a limiting assembly. The rod includes an axial hole, a locking hole, a sliding groove, a driving end, and a driving portion adapted to connect to a socket. The locking hole is connected to the driving portion. The limiting assembly includes a locking rod, a locking member, a first ring, and a first linkage rod. The locking rod is slidably arranged in the axial hole, and the locking member abuts against the locking rod. The first ring covers the driving portion in a release state, enabling quick socket release with a single-hand press.

### BACKGROUND OF THE INVENTION

The present invention relates to a socket adapter, particularly a single-hand quick-press release socket adapter.

Taiwan Patent No. TWM562194 discloses a quick-release device for a connecting rod tool. The device is provided with a socket column for socketing a working tool at the first end of a main body, and a latch bead that can be displaced laterally is convexly provided on one side of the socket column, a push rod is axially inserted into the axial hole of the main body, and the push rod is provided with a groove at a position corresponding to the latch bead, and a sliding sleeve is sleeved on the outer circumference of the main body, and the sliding sleeve is provided with at least one assembly hole and an inner concave annular groove communicating with the assembly hole, so that a latch pin can be laterally extended through the push rod and limited in the inner concave annular groove of the sliding sleeve.

However, the aforementioned connecting rod tool operates by causing the latch bead to protrude outward or retract inward through the forward and backward displacement of the push rod. To achieve this displacement, the user must operate the sliding sleeve to move forward or backward while simultaneously holding the socket for attachment to the socket column. This process requires two-handed operation for assembling or disassembling the socket, which is not conducive to quick replacement of the socket.

In view of the shortcomings of the conventional structure described above, the inventor has developed a single-hand quick-press release socket adapter that overcomes all the disadvantages of the conventional structure.

### SUMMARY OF THE INVENTION

A single-hand quick-press release socket adapter in the embodiment of the present invention includes a rod and a limiting assembly. The rod includes an axial hole axially arranged along a virtual pivoting axis, a locking hole and a sliding groove radially arranged along the pivoting axis and communicating with the axial hole, a driving end, and a driving portion disposed at an outer periphery of the driving end in a radial direction of the pivoting axis and adapted to connect to a socket. The locking hole has one end opposite to the axial hole and connected to the driving portion. The limiting assembly includes a locking rod, a locking member, a first ring, and a first linkage rod. The locking rod is slidably arranged in the axial hole. The locking member is disposed in the locking hole and abuts against the locking rod. The first ring is sleeved on the rod. The first linkage rod is arranged in the sliding groove and has one end connected to the locking rod and the other end connected to the first ring. The limiting assembly is switchable between a release state and a locking state. When the limiting assembly is in the release state, the first ring moves in a direction toward the driving end and covers the driving portion, and the locking member retracts inward toward the pivoting axis. When the limiting assembly is in the locking state, the first ring moves in a direction away from the driving end, and the locking member protrudes outward away from the pivoting axis.

In an embodiment, an outer periphery of the locking rod is provided with a first abutting portion and a second abutting portion connected to one end of the first abutting portion adjacent to the driving end. A distance from the first abutting portion to the outer periphery of the locking rod defines a first depth, and a distance from the second abutting portion to the outer periphery of the locking rod defines a second depth. The second depth is smaller than the first depth. When the limiting assembly is in the release state, the locking member abuts against the first abutting portion. When the limiting assembly is in the locking state, the locking member abuts against the second abutting portion.

In an embodiment, the limiting assembly includes a second ring, a second linkage rod, and an elastic member. The second ring is axially movably sleeved on the rod along the pivoting axis and positioned on a side of the first ring opposite to the driving end. The second linkage rod has one end connected to the second ring and the other end passing through the sliding groove and inserted into the axial hole. The elastic member is arranged in the axial hole and has one end abutting against one end of the locking rod opposite to the driving end and the other end abutting against the second linkage rod. The elastic member is capable of pushing the locking rod in the direction toward the driving end.

In an embodiment, an inner periphery of the second ring is provided with a wide section and a narrow section. A width of the wide section in the radial direction of the pivoting axis defines a first width, and a width of the narrow section in the radial direction of the pivoting axis defines a second width. The second width is smaller than the first width. The wide section is sleeved on an outer periphery of the first ring. The narrow section is positioned on a side of the wide section opposite to the driving end and capable of abutting against an outer periphery of the rod.

In an embodiment, the locking rod is provided with an insertion hole in the radial direction of the pivoting axis. The first ring is provided with a first side hole in the radial direction of the pivoting axis. The second ring is provided with a second side hole in the radial direction of the pivoting axis. One end of the first linkage rod is inserted into the insertion hole, and the other end is inserted into the first side hole. One end of the second linkage rod opposite to the axial hole is inserted into the second side hole.

The present invention will become clearer in light of the following detailed description of illustrative embodiments of this invention described in connection with the drawings.

### BRIEF DESCRIPTION OF DRAWINGS

FIG. 1 is a perspective view of a single-hand quick-press release socket adapter of an embodiment according to the present invention.

FIG. 2 is an exploded perspective view of the single-hand quick-press release socket adapter in FIG. 1.

FIG. 3 is a cross sectional view of the single-hand quick-press release socket adapter in FIG. 1 and shows a limiting assembly in a release state.

FIG. 4 is a cross sectional view of the single-hand quick-press release socket adapter in FIG. 1 and shows the limiting assembly in a locking state.

FIG. 5 is a cross sectional view of the single-hand quick-press release socket adapter in FIG. 1 and shows the limiting assembly switched from the locking state to the release state.

### DETAILED DESCRIPTION OF THE INVENTION

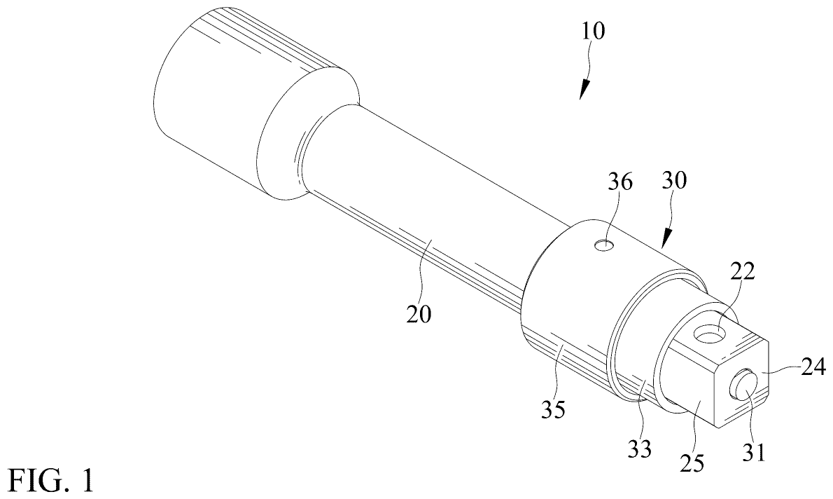

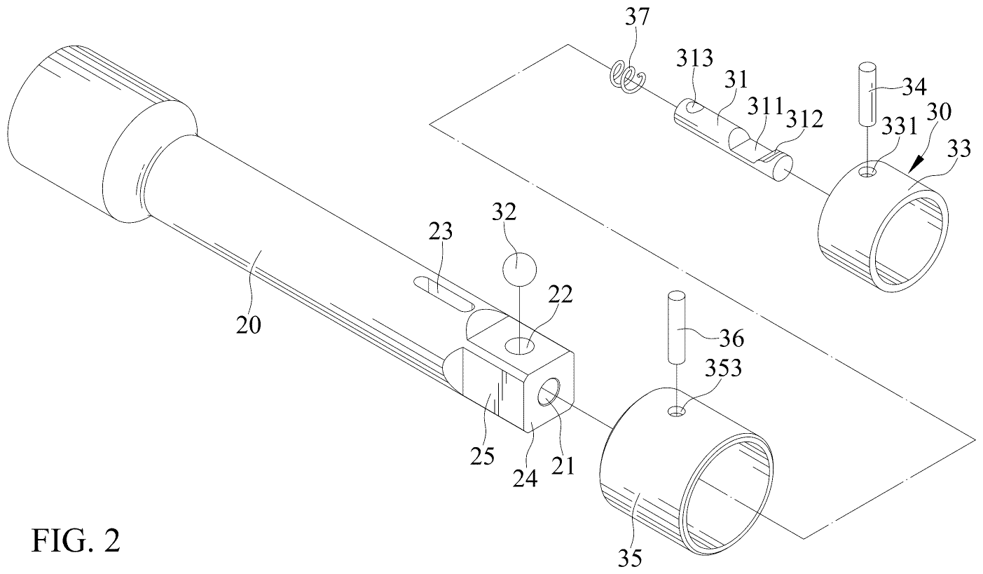

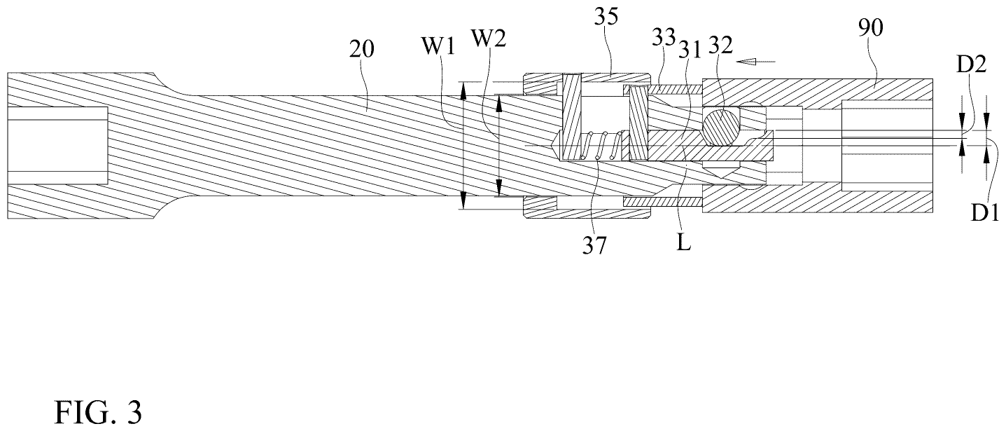

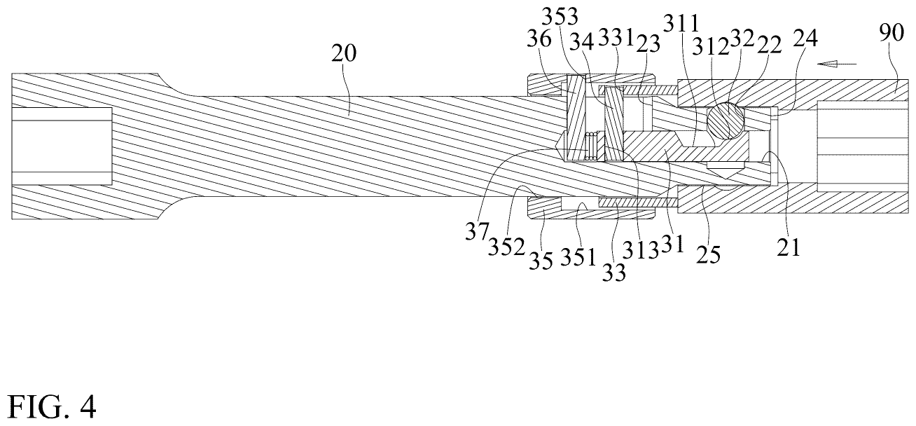

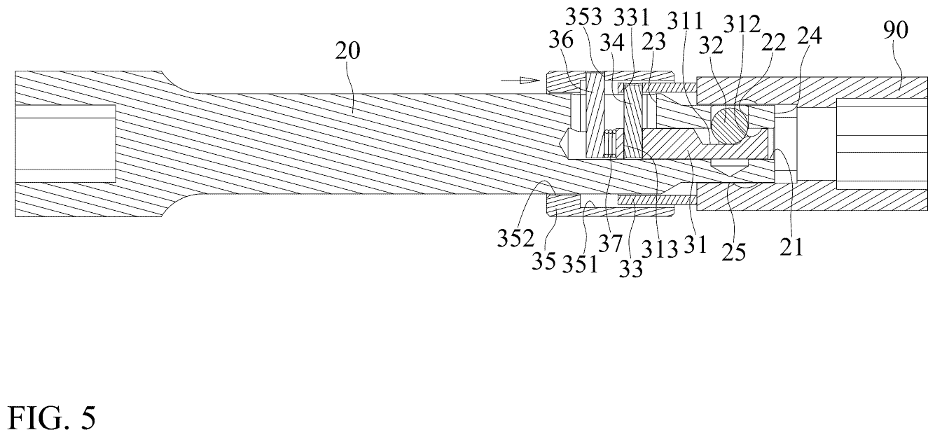

Referring to FIGS. 1 to 5, this embodiment provides a single-hand quick-press release socket adapter 10, which includes a rod 20 and a limiting assembly 30.

The rod 20 includes an axial hole 21 arranged along a virtual pivoting axis L, a locking hole 22, and a sliding groove 23. The locking hole 22 and the sliding groove 23 are radially arranged along the pivoting axis L and communicate with the axial hole 21. The rod 20 further includes a driving end 24, and a driving portion 25 is disposed at an outer periphery of the driving end 24 in the radial direction of the pivoting axis L, adapted to connect to a socket 90. The locking hole 22 has one end opposite to the axial hole 21 and is connected to the driving portion 25.

The limiting assembly 30 includes a locking rod 31, a locking member 32, a first ring 33, and a first linkage rod 34. The locking rod 31 is slidably arranged in the axial hole 21. The locking member 32 is disposed in the locking hole 22 and abuts against the locking rod 31. The first ring 33 is sleeved on the rod 20. The first linkage rod 34 is arranged in the sliding groove 23, with one end connected to the locking rod 31 and the other end connected to the first ring 33. The limiting assembly 30 is switchable between a release state and a locking state. When in the release state, the first ring 33 moves in a direction toward the driving end 24 and covers the driving portion 25, while the locking member 32 retracts inward toward the pivoting axis L. When in the locking state, the first ring 33 moves in a direction away from the driving end 24, and the locking member 32 protrudes outward away from the pivoting axis L.

An outer periphery of the locking rod 31 is provided with a first abutting portion 311 and a second abutting portion 312, which is connected to one end of the first abutting portion 311 adjacent to the driving end 24. A distance from the first abutting portion 311 to the outer periphery of the locking rod 31 defines a first depth D1, while a distance from the second abutting portion 312 to the outer periphery of the locking rod 31 defines a second depth D2, where the second depth D2 is smaller than the first depth D1. When in the release state, the locking member 32 abuts against the first abutting portion 311. When in the locking state, the locking member 32 abuts against the second abutting portion 312.

The limiting assembly 30 further includes a second ring 35, a second linkage rod 36, and an elastic member 37. The second ring 35 is axially movably sleeved on the rod 20 along the pivoting axis L and positioned on a side of the first ring 33 opposite to the driving end 24. One end of the second linkage rod 36 is connected to the second ring 35, and the other end passes through the sliding groove 23 and is inserted into the axial hole 21. The elastic member 37 is arranged in the axial hole 21, with one end abutting against one end of the locking rod 31 opposite to the driving end 24 and the other end abutting against the second linkage rod 36. The elastic member 37 is capable of pushing the locking rod 31 in the direction toward the driving end 24.

An inner periphery of the second ring 35 is provided with a wide section 351 and a narrow section 352. A width of the wide section 351 in the radial direction of the pivoting axis L defines a first width W1, while a width of the narrow section 352 in the radial direction of the pivoting axis L defines a second width W2, where the second width W2 is smaller than the first width W1. The wide section 351 is sleeved on an outer periphery of the first ring 33, and the narrow section 352 is positioned on a side of the wide section 351 opposite to the driving end 24 and capable of abutting against an outer periphery of the rod 20.

The locking rod 31 is provided with an insertion hole 313 in the radial direction of the pivoting axis L. The first ring 33 is provided with a first side hole 331 in the radial direction of the pivoting axis L, and the second ring 35 is provided with a second side hole 353 in the radial direction of the pivoting axis L. One end of the first linkage rod 34 is inserted into the insertion hole 313, and the other end is inserted into the first side hole 331. One end of the second linkage rod 36, opposite to the axial hole 21, is inserted into the second side hole 353.

With the above structure, the socket adapter 10 enables quick socket release with a single-hand press. To attach a socket 90 to the socket adapter 10, the user only needs to insert the socket 90 onto the driving portion 25. Simultaneously, the socket 90 pushes the first ring 33 to move, and through the linkage relationship between the first ring 33, the first linkage rod 34, and the locking rod 31, the limiting assembly 30 switches to the locking state, thereby securing the socket 90. To remove the socket 90, the user only needs to push the second ring 35 forward. The second linkage rod 36 compresses the elastic member 37, which, in turn, presses the locking rod 31, causing the limiting assembly 30 to switch to the release state. The first ring 33 then pushes the socket 90 outward for removal. Both attachment and removal of the socket 90 can be completed with one hand.

Although specific embodiments have been illustrated and described, numerous modifications and variations are still possible without departing from the scope of the invention. The scope of the invention is limited by the accompanying claims.

1. A single-hand quick-press release socket adapter, comprising:
a rod including an axial hole axially arranged along a virtual pivoting axis, a locking hole and a sliding groove radially arranged along the pivoting axis and communicating with the axial hole, a driving end, and a driving portion disposed at an outer periphery of the driving end in a radial direction of the pivoting axis and adapted to connect to a socket, and wherein the locking hole has one end opposite to the axial hole and connected to the driving portion; and
a limiting assembly including a locking rod, a locking member, a first ring, and a first linkage rod, wherein the locking rod is slidably arranged in the axial hole, wherein the locking member is disposed in the locking hole and abuts against the locking rod, wherein the first ring is sleeved on the rod, wherein the first linkage rod is arranged in the sliding groove and has one end connected to the locking rod and the other end connected to the first ring, and wherein the limiting assembly is switchable between a release state and a locking state;
wherein when the limiting assembly is in the release state, the first ring moves in a direction toward the driving end and covers the driving portion, and the locking member retracts inward toward the pivoting axis;
wherein when the limiting assembly is in the locking state, the first ring moves in a direction away from the driving end, and the locking member protrudes outward away from the pivoting axis.

2. The single-hand quick-press release socket adapter of claim 1, wherein an outer periphery of the locking rod is provided with a first abutting portion and a second abutting portion connected to one end of the first abutting portion adjacent to the driving end, wherein a distance from the first abutting portion to the outer periphery of the locking rod defines a first depth, wherein a distance from the second abutting portion to the outer periphery of the locking rod defines a second depth, and wherein the second depth is smaller than the first depth;
wherein when the limiting assembly is in the release state, the locking member abuts against the first abutting portion;
wherein when the limiting assembly is in the locking state, the locking member abuts against the second abutting portion.

3. The single-hand quick-press release socket adapter of claim 1, wherein the limiting assembly includes a second ring, a second linkage rod, and an elastic member, wherein the second ring is axially movably sleeved on the rod along the pivoting axis and positioned on a side of the first ring opposite to the driving end, wherein the second linkage rod has one end connected to the second ring and the other end passing through the sliding groove and inserted into the axial hole, wherein the elastic member is arranged in the axial hole and has one end abutting against one end of the locking rod opposite to the driving end and the other end abutting against the second linkage rod, and wherein the elastic member is capable of pushing the locking rod in the direction toward the driving end.

4. The single-hand quick-press release socket adapter of claim 3, wherein an inner periphery of the second ring is provided with a wide section and a narrow section, wherein a width of the wide section in the radial direction of the pivoting axis defines a first width, wherein a width of the narrow section in the radial direction of the pivoting axis defines a second width, wherein the second width is smaller than the first width, wherein the wide section is sleeved on an outer periphery of the first ring, and wherein the narrow section is positioned on a side of the wide section opposite to the driving end and capable of abutting against an outer periphery of the rod.

5. The single-hand quick-press release socket adapter of claim 3, wherein the locking rod is provided with an insertion hole in the radial direction of the pivoting axis, wherein the first ring is provided with a first side hole in the radial direction of the pivoting axis, wherein the second ring is provided with a second side hole in the radial direction of the pivoting axis, wherein one end of the first linkage rod is inserted into the insertion hole, and the other end is inserted into the first side hole, and wherein one end of the second linkage rod opposite to the axial hole is inserted into the second side hole.
